(19) United States
(12) Patent Application Publication
(10) Pub. No.: US 2013/0232133 A1
(43) Pub. Date: Sep. 5, 2013

(54) SYSTEMS AND METHODS FOR PERFORMING A NESTED JOIN OPERATION

(71) Applicants: Awny K. Al-Omari, Cedar Park, TX (US); Qifan Chen, Austin, TX (US); Michael J. Hanlon, Austin, TX (US)

(72) Inventors: Awny K. Al-Omari, Cedar Park, TX (US); Qifan Chen, Austin, TX (US); Michael J. Hanlon, Austin, TX (US)

(21) Appl. No.: 13/885,003

(22) PCT Filed: Dec. 3, 2010
(86) PCT No.: PCT/US10/58817

§ 371 Date: May 13, 2013

(51) Int. Cl. G06F 17/30

(52) U.S. Cl. CPC G06F 17/30466
USPC 707/714

(57) ABSTRACT

Systems and methods are provided for performing a nested join operation. Partitioning key values are computed for an outer data source using a partitioning key function used to partition an inner table. A join process is established for each of a plurality of partitions of the inner table (at 204), with a given partition of the inner table representing a plurality of partitioning key values. Each row from the outer data source is routed to a join process according to its associated partitioning key value (at 206). The inner table is probed to return a row from the inner table having the partitioning key value associated with the row from the outer data source (at 208). The row from the outer data source and the row returned from the inner table are joined to form a row in a combined table (at 210).

### TECHNICAL FIELD

This invention relates to information processing, and more particularly, to systems and methods for performing a nested join operation.

### BACKGROUND

Relational database systems store tables of data which are typically linked together by relationship that simplify the storage of data and make queries of the data more efficient. Structured Query Language (SQL) is a standardized language for creating and operating on relational databases. Join operations can be used in SQL queries to combine data, sets from multiple database tables. A common use of the join operation is to combine those rows from an outer table to rows of an inner table which have equal values for a set of columns in both tables. This set of columns is known as the join key.

In parallel database systems, the tables are usually partitioned on the basis of values in a set of columns which can be called the partitioning key. If the join key is a superset of the partitioning key of the inner table, a nested join operation can be performed by using the partitioning key columns of the join key produced from the outer table to select the correct partition of the inner table to probe.

### BRIEF DESCRIPTION OF THE DRAWINGS

FIG. 1 illustrates an example of a database system that combines records via an outer child repartition join scheme.

FIG. 2 is a schematic diagram illustrating an example of a query plan utilizing an outer child repartition scheme for performing a nested join.

FIG. 3 illustrates an example method for performing a nested join.

FIG. 4 illustrates an example of a computer system that can be employed to implement the systems and methods illustrated in FIGS. 1-3.

### DETAILED DESCRIPTION

In parallel database systems, it is common to use multiple processes to perform a nested join operation for a single query. Such a parallel nested join performed with a partitioned inner table can require all processes to access all inner partitions, which results in an explosion in the resources needed for a single query. In addition, in large systems, join operations can be so computationally expensive, as to limit the number of join operations that can be performed at any given time.

To this end, a database system is provided that reduces the computational expense of nested join operations. Further, the system avoids the introduction of data skew, which could cause some processes to work much harder than others in scenarios where values of the partitioning key of the inner table are not evenly distributed in the outer table. A cache of probed rows from the inner table can also be employed as part of the solution to prevent data skew problems.

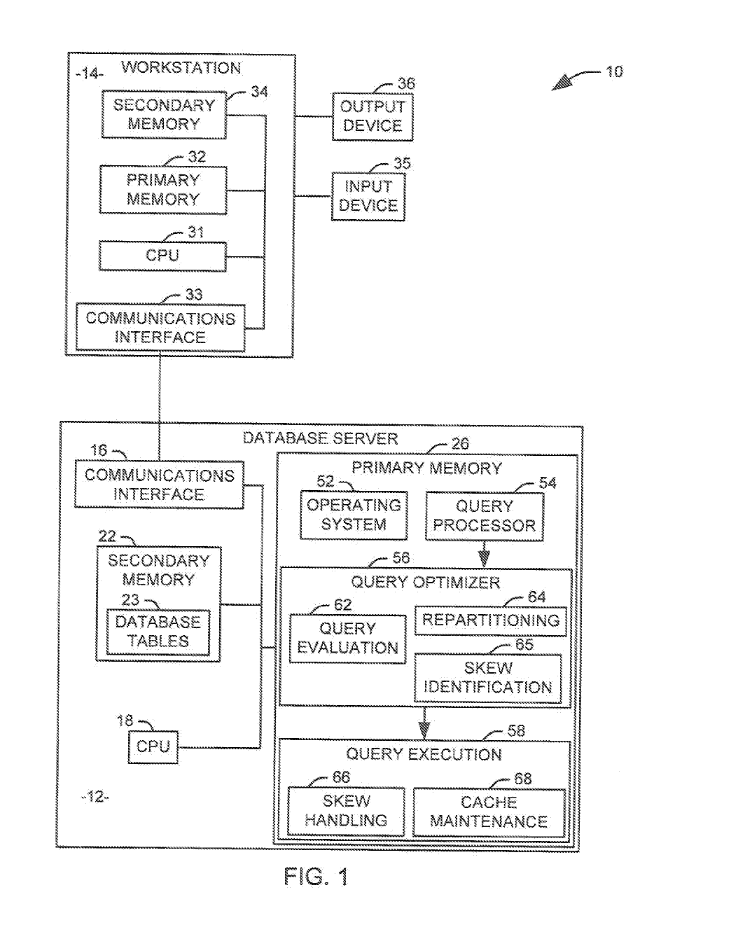

FIG. 1 illustrates an example of a database system 10 having a massively parallel processing architecture that combines records from tables within a database via an outer child repartition (OCR) join scheme in response to a query containing a nested join. The system 10 can be a distributed computer system having multiple computers interconnected by local area and wide area network communication media 16. In the example of FIG. 1, the system 10 includes a database server 12 and a workstation computer 14, although the system can include more than one server or workstation computer.

As an example, the database server 12 can be implemented as a SQL database engine that manages the control and execution of SQL queries. The workstation computer 14 passes SQL queries to the database server 12. A user operating the workstation computer 14 can transmit a SQL query to retrieve and/or modify a set of database tables 23 that are stored in the database server 12. The SQL database engine of the server 12 generates an optimized plan for executing the SQL query and then executes the plan.

The database server 12 can include a central processing unit (CPU) 18, primary memory 28, secondary memory 22, a communications interface 16 for communicating with user workstation 14 as well as other system resources. The secondary memory 22 can store database tables 23. In a massively parallel processing architecture, the database tables will be partitioned, and different partitions of the database tables can be stored in different database servers. It will be understood, however, that from the perspective of the user workstation computer 14, the database server 12 can be viewed as a single entity.

The user workstation 14 can include a central processing unit (CPU) 31, primary memory 32, a communications interface 33 for communicating with the database server 12 and other system resources, secondary memory 34, an input device 35, and an output device 36. The input device 35 can include any of a keyboard, a touchscreen, a pointing device, a microphone, and/or a similar device to allow a user to convey commands and interact with methods and functions on the workstation 14. The output device 36 can comprise any of a display device, a speaker, a printer, a tactile display, and/or a similar device for conveying information to a user in a form comprehensible to a human being. Secondary memory 34 can be used for storing computer programs, such as communications software used to access the database server 12. Some end user workstations 14 may be “dumb” terminals that do not include any secondary memory 34, and thus execute only software downloaded into primary memory 32 from a server computer, such as the database server 12 or another server (not shown).

The primary memory 26 of the database server 12 contains an operating system 52, a query processor 64, a query optimizer 56, and a query execution engine 58. The query processor 54 parses an input query, for example, a query written in SQL (Structured Query Language), to convert the input query into an internal representation referred to as a query tree. The query tree represents the expression to be optimized along with any required physical properties. The query processor 54 structures the query tree in a manner that is efficiently readable by the query optimizer 55. The query optimizer 56 generates execution plans for the input query. Associated with each execution plan is a cost for executing the plan, and the query optimizer 56 determines a selected plan having a minimal cost. The selected plan is used by the query execution engine 58 to execute the input query.

The database server 12 can utilize an outer child repartition (OCR) scheme for performing a nested join operation from the input query. Accordingly, the query optimizer 56 includes a query evaluation component 62 that determines if a given nested join operation is an appropriate candidate for the OCR scheme. For example, the evaluation component 62 can review the predicates associated with the join operation to ensure that the operation uses only equality comparisons. If the join operation is not suitable for the OCR scheme, another appropriate optimization procedure can be applied to perform the requested join operation.

If the on operation is determined to be suitable for application of the OCR scheme, a repartitioning component 84 initiates a repetition of the outer data source of the join. For example, a hash function identical to that used to partition the inner table can be used to compute hash values from partitioning keys derived from join keys read from the rows of the outer data source. Exchange operators can be placed within the query plan to route rows having a given hash value to a join process associated with the corresponding inner table partition. A skew identification component 65 can identify partitioning key values for the outer data source that occur with high frequency. For example, the skew identification component 65 can collect statistics for columns corresponding to those used as the partitioning key to identify values occurring in the outer table with a frequency greater than a threshold value, referred to herein as skewed partitioning key values. Rows in the outer table that contain these skewed partitioning key values will be referred herein as skewed rows. The identified skewed partitioning key values can be provided to the query execution engine 58.

The query execution engine 58 executes the join operation to provide combined table including data from the outer data source and the inner table. The join operation is performed in parallel at a plurality of join processes, each, join process handling rows from an associated partition of the inner table. As a result, extensive communication between the partition and the other join processes is unnecessary. The rows from the outer data source are routed to a join process selected as a function of the row's partitioning key value.

To avoid problems due to presence of skewed partitioning key values in the outer data source, the query execution engine 58 can include a skew handling component 66 that is programmed to alter the routing of rows from the outer data source that have been identified as skewed rows. For example, the skew handling component 66 can route skewed rows substantially randomly among the plurality of join processes being executed for a given query. Alternatively, the skew handling component 66 can select a set of predetermined join processes for each skewed row value. For example, for a given row value, every q^{th} join process can be selected, where, q is an integer greater than one. This has the advantage of limiting the number of possible connections that will be formed between a given partition of the inner table and a set of join processes, thereby maintaining the low complexity of the OCR nested join. The number of join processes selected can vary depending on the degree of skew represented by the row value.

The query execution engine 58 can further include a cache maintenance component 68 that is programmed to maintain a probe cache associated with each join process. Row returned by probes of the inner table during the join operation, can be stored in the cache to be reused when probes with duplicate join keys are received from the outer data source. As an example, each probe cache is managed according to a second-chance heuristic, in which a given row is flagged when it would be selected for replacement within the cache and only a previously flagged entry is selected for replacement.

The example system 10 can significantly increase the efficiency of nested join operations in a massively parallel database architecture. For example, by repartitioning the outer data source, the system 10 effectively reduces the system resource consumption from O(n*m) to O(n), where n denotes the number of join processes and m denotes the number of partitions of the inner table. This allows for the execution of more simultaneous queries on the database tables 23 utilizing the OCR nested join scheme. Further, the example OCR scheme mitigates the possible data skew caused by data repartition by identifying the potential skewed partitioning key values during compilation and building an effective row distribution method into the execution plan. For instance, during query execution, skewed rows are detected and routed to designated join operators, with the number of such join operators being restricted to retain the benefit of the OCR scheme. Additionally, the OCR scheme builds a probe cache in each join operator to cache the result of a probe into the inner table, allowing repeated probing to the inner table for the same join key value to be reduced.

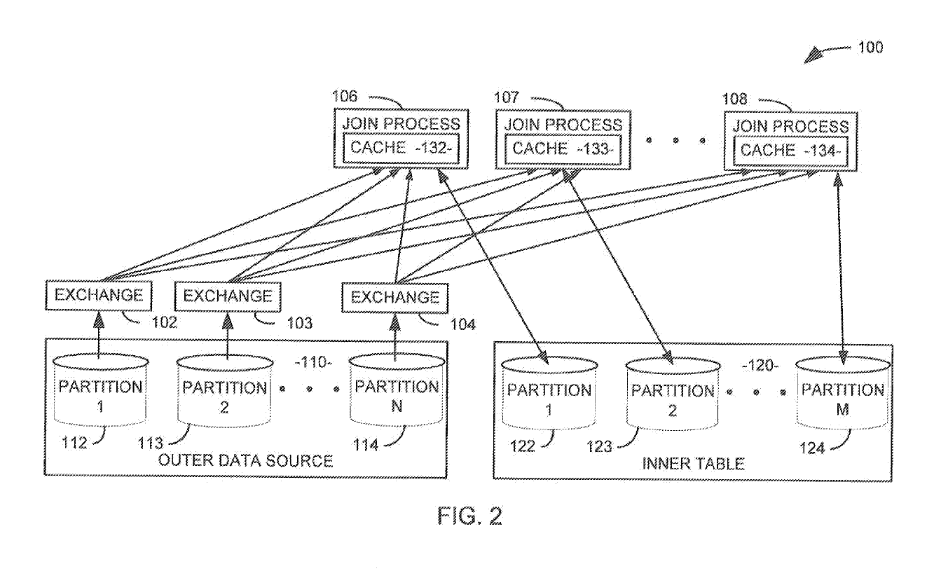

FIG. 2 is a schematic diagram illustrating one example of a query plan 100 utilizing an outer child repartition (OCR) scheme for performing a nested join. In the illustrated nested join scheme, the query optimizer has inserted EXCHANGE operators 102, 103 and 104 between the join processes 106, 107 and 108 and the outer source 110 requesting that the outer source be repartitioned to match the inner table 120. In the example of FIG. 2, the outer source includes a plurality of partitions 12, 113 and 114.

By way of example, each EXCHANGE operator 102, 103 and 104 can utilize a hash function that is identical to the one used to partition the inner table 120 to compute hash values for partitioning key values read, from rows from the outer data source 110. These rows are then routed to the join processes 106, 107 and 108 according to their hash values. In the example scheme of FIG. 2, the join processes 106, 107 and 108 are established such that each partition 122, 123 and 124 of the inner table 120 has a corresponding join process. Since the rows from the outer source 110 are hashed the same (e.g., via using same hash functions with columns corresponding to the inner table partitioning key) as the rows in the inner table 120, all rows received by a join process can be evaluated against the matching partition 122, 123 and 124 of the inner table. Thus, each partition 122, 123 and 124 communicates primarily with one join process 106, 107 and 108. The complexity of the system resource is thus effectively reduced to O(n), where n is the number of partitions 122-124 of the inner table 120.

When the hash values associated with rows in the outer source 110 are uniformly distributed, each join process 106, 107 and 108 sees about the same number of rows. As discussed previously, however, it is common for various partitioning key values to occur with significantly greater frequency in the outer table. For example, the skewed rows can occur due to the prominence of a particular country, company, or division within the outer source 110, which will vary depending the purpose of the data being stored. In such a case, a large number of rows can sent to the same join process (e.g., 106), forcing such join process to process significantly more rows and slowing the execution of the query. To avoid this type of processing imbalance, the OCR scheme detects skewed rows in advance and evenly distributes them to multiple join processes. For example, the exchange nodes 102, 103 and 104 can send each skewed row to a randomly selected join process or to a set of every q^{th} join process, where q is an integer greater than on It will thus be appreciated that while a given partition (e.g., 122) of the inner table 120 generally communications solely with its associated join process (e.g., 106), the partition can engage in limited communication with join processes other than its associated join process if the partition will be probed by skewed rows. Skew handling join operators can be the same for all skew values, or different skew handling join operators can be used for each skew value.

To reduce the number of probes from the join process to the inner table 120 further, the OCR join scheme utilizes a plurality of probe caches 132, 133 and 134 between each join operator 106, 107 and 108 and its associated partition 122, 123 and 124 of the inner table. For instance, the probe caches 132, 133 and 134 are inserted between the join process (e.g., 106) and the associated the inner table for a query in which there can be duplicate probes from the outer data source. During execution of the query, each probe of the inner table 120 is stored in the cache until forced out of the cache by new data. As an example, each cache 132, 133 and 134 is managed according to a second chance heuristic). For instance, the cache can operate as a first in, first out (FIFO) modified by a second chance heuristic in which recently accessed rows are exempted from removal from the cache.

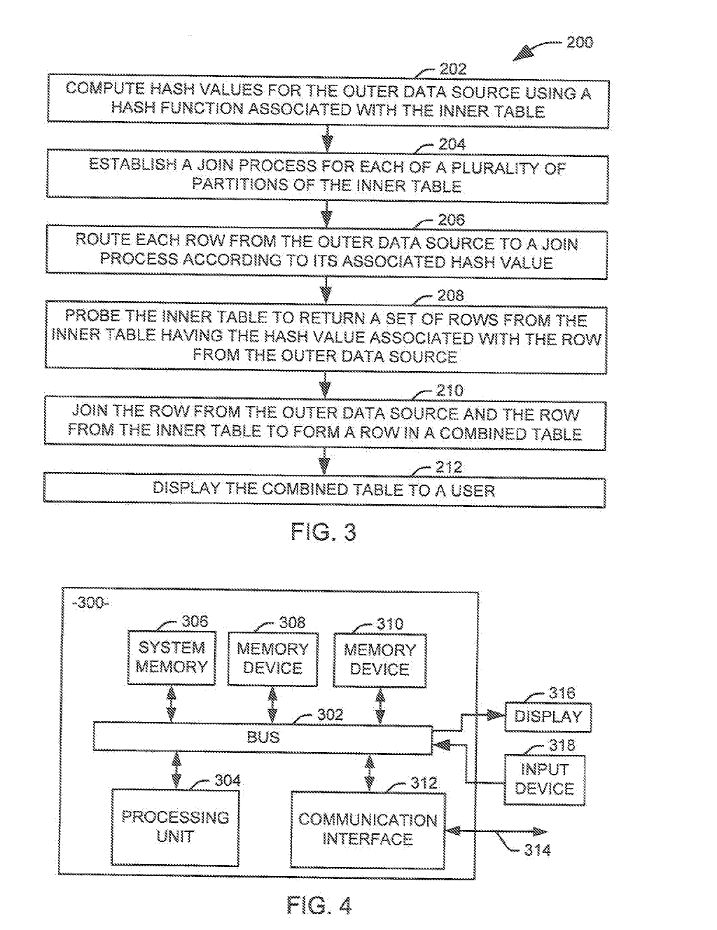

In view of the foregoing structural and functional features described above, an example method will be better appreciated with reference to FIG. 3. While, for purposes of simplicity of explanation, the method of FIG. 3 is shown and described as executing serially, it is to be understood and appreciated that some actions could in other examples occur in different orders and/or concurrently from that shown and described herein.

FIG. 3 illustrates a method 200 for performing a parallel nested join operation on an inner table and an outer data source on an associated join key. In one implementation, when an SQL query is received requesting a join operation, the query is evaluated to determine if a nested join method would be effective. For example, the predicates associated with the join operation can be reviewed to ensure that the operation only uses equality comparisons, and that all inner table partition key columns are referenced by the equality comparison join predicate. If the query is not suitable for the method 200, another join method can be utilized.

At 202, hash values are computed for columns from the outer table, which correspond to the partitioning key of the inner table, using the same hash function used to partition the inner table. A join process is established for each of a plurality of partitions of the inner table at 204. Each partition of the inner table represents a plurality of partitioning key values for the rows in the inner table.

At 206, each row from the outer data source is routed to a join process according to the values of its columns corresponding to the partitioning key of the inner table. For example, each row can be routed to a join process associated with en inner table partition. In one example, the routing can be accomplished by inserting a plurality of exchange operations into a query plan associated with the join operation. The routing can be performed to avoid overloading one of the join processes via a skew handling method. For instance, it can be determined if the values of the outer table columns which correspond to the inner table partitioning key occur in the outer data source with a frequency greater than a threshold value. If the frequency exceeds the threshold value, the value is considered to be skewed and is distributed across multiple join processes to avoid overloading any join process. Each skewed row from the outer data source is routed to a plurality of join processes from the set of join processes. For example, the plurality of join processes can selected as every q^{th} join process from the set of join processes, where q is an integer greater than one, or randomly selected from the set of join processes. Otherwise, the row from the outer data source is routed to the join process associated with its partitioning function only if it is determined that the values of the columns used in the partitioning function (i.e., columns corresponding to the inner table partitioning key) occur in the outer data source with a frequency that is less than the threshold value.

At 208, the inner table is probed to return a set of rows from the inner table having the join key value associated with the row from the outer data source. In one example, the results of the probe are cached in a probe cache at the join process. Each cache can be managed according to a second chance heuristic, wherein cache can operate in a first in, first out (FIFO) arrangement modified by a second chance heuristic in which recently accessed rows are exempted from removal from the cache. At 210, the row from the outer data source and the rows from the inner table are joined to form a set of rows in a combined table. A representation of the combined table can be displayed to a user at 212.

FIG. 4 is a schematic block diagram illustrating an exemplary system 300 of hardware components capable of implementing examples of the present disclosed in FIGS. 1-3, such as the database systems illustrated in FIG. 1. The system 300 can include various systems and subsystems. The system 300 can be a personal computer, a laptop computer, a workstation, a computer system, an appliance, an application-specific integrated circuit (ASIC), a server, a server blade center, a server farm, etc.

The system 300 can include a system bus 302, a processing unit 304, a system memory 306, memory devices 308 and 310, a communication interface 312 (e.g., a network interface), a communication link 314, a display 316 (e.g., a video screen), and an input device 318 (e.g., a keyboard and/or a mouse). The system bus 302 can be in communication with the processing unit 304 and the system memory 306. The additional memory devices 308 and 310, such as a hard disk drive, server, stand alone database, or other non-volatile memory, can also be in communication with the system bus 302. The system bus 302 operably interconnects the processing unit 304, the memory devices 306-310, the communication interface 312, the display 316, and the input device 318. In some examples, the system bus 302 also operably interconnects an additional port (not shown), such as a universal serial bus (USB) port.

The processing unit 304 can be a computing device and can include an application-specific integrated circuit (ASIC). The processing unit 304 executes a set of instructions to implement the operations of examples disclosed herein. The processing unit can include a processing core.

The additional memory devices 306, 308 and 310 can store data, programs, instructions, database queries in text or compiled form, and any other information that can be needed to operate a computer. The memories 306, 308 and 310 can be implemented as computer-readable media (integrated or removable) such as a memory card, disk drive, compact disk (CD), or server accessible over a network. In certain examples, the memories 306, 308 and 310 can comprise text, images, video, and/or audio, portions of which can, be available in different human.

Additionally, the memory devices 308 and 310 can serve as databases or data storage. Additionally or alternatively, the system 300 can access an external data source or query source through the communication interface 312, which can communicate with the system bus 302 and the communication link 314.

In operation, the system 300 can be used to implement a database system that executes an inner nested join operation based on an outer child repartition in response to an appropriate database query, such as shown and described with respect to FIGS. 1 to 3. The queries can be formatted in accordance with various query database protocols, including SQL. Computer executable logic for implementing the real-time analytics system resides on one or more of the system memory 306, and the memory devices 308, 310 in accordance with certain examples. The processing unit 304 executes one or more computer executable instructions originating from the system memory 306 and the memory devices 308 and 310. The term “computer readable medium” as used herein refers to a medium that participates in providing instructions to the processing unit 304 for execution.

What have been described above are examples. It is, of course, not possible to describe every conceivable combination of components or methodologies, but one of ordinary skill in the art will recognize that many further combinations and permutations are possible. Accordingly, the invention is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A method for performing a nested join operation comprising:
computing (202) partitioning key values for an outer data source, representing respective row values in an associated join key, using a hash function that is used to partition an inner table;
establishing (204) a join process for each of a plurality of partitions of the inner table, a given partition of the inner table representing a plurality of partitioning key values;
routing (206) each row from the outer data source to a join process according to its associated partitioning key value, such that each row is routed to a join process associated with the partition representing the partitioning key value of the respective row;
probing (208) the inner table to return a row from the inner table having join key value associated with the row from the outer data source; and
joining (210) the row from the outer data source and the row returned from the inner table to form a row in a combined table.

2. The method of claim 1, further comprising caching the row returned from the inner table (120) in a probe cache (134) at the join process (108).

3. The method of claim 2, further comprising managing the probe cache (134) via a cache replacement policy.

4. The method of claim 1, further comprising inserting a plurality of exchange operations (102, 103, 104) into a query plan associated with the join process (108) to facilitate routing each row from the cuter data source (110) to a corresponding join process (108).

5. The method of claim 1, wherein routing each row from the outer data source (110) further comprises routing the row from the outer data source (110) to the join process (108) if it is determined that the partitioning key value associated with the row from the outer data source (110) occurs in the outer data source with a frequency that is less than a threshold value.

6. The method of claim 5, wherein the join process (108) is a first join process of a set of join processes (106, 107, 108) and routing the row from the outer data source (110) further comprises routing the row to a plurality of join processes from the set of join processes if it is determined that the partitioning key value associated with the row from the outer data source occurs in the outer data source with a frequency greater than a threshold value.

7. The method of claim 6, wherein the plurality of join processes are randomly selected from the set of join processes (106, 107, 108).

8. The method of claim 6, wherein the plurality of join processes (106, 107) are selected as every q^{th} join process from the set of join processes, where q is an integer greater than one.

9. The method of claim 1, further comprising:
receiving an SQL query requesting the join process (108); and
evaluating the SQL query to determine if it would be effective to compute partitioning key values for the outer data source using a partitioning function that was used to partition the inner table.

10. The method of claim 9, wherein evaluating the SQL query further comprises reviewing the predicates associated with the join process to ensure that the operation includes equality comparisons.

11. A non-transitory computer readable medium to store executable instructions for performing a nested join operation, the executable instructions comprising:
a query optimizer (56) comprising:
a query evaluation component (62) to evaluate an SQL query to determine if it would be effective to compute partitioning key values for a join key of an outer data source using a partitioning function used to compute partitioning key values for the join column in an inner table; and
a repartitioning component (64) to repartition the outer table using the partitioning function if it is determined to be effective to compute the partitioning key values and to establish a join process for each of a plurality of partitions of the inner table, a given partition of the inner table representing a plurality of partitioning key values; and
a query execution engine (58) to route each row from the outer data source to a join process according to its associated partitioning key value, such that each row is routed to a join process associated with the partition representing the partitioning key value of the row, probe the inner table to return a row from the inner table having the join key value associated with the row from the outer data source, and join the row from the outer data source and the row from the inner table to form a row in a combined table, the query execution engine further comprising:
a skew handling component (66) to alter the routing of row from the outer data source if the partitioning key value associated with the row from the outer data source occurs in the outer data source with a frequency greater than a threshold value, and
a cache maintenance component (68) to cache the row from the inner table in a probe cache at the join process.

12. A system comprising:
memory (26) to store executable instructions for performing a nested join operation on an inner table and an outer data source on an associated join column, the executable instructions comprising:
a query optimizer (56) to repartition the outer table, using a hash function associated with the inner table and establish a join process for each of a plurality of partitions of the inner table, a given partition of the inner table representing a plurality of hash values; and
a query execution engine (58) to route each row from the outer data source to a join process according to an associated partitioning key value, such that each row is routed to a join process associated with the partition representing the partitioning key value of the row, probe the inner table to return a row from the inner table having the join key value associated with the row from the outer data source, and join the row from the outer data source and the row from the inner table to form a row in a combined table; and
a processor (18) to execute the executable instructions in the memory.

13. The system of claim 12, the query optimizer (56) further comprising a query evaluation component (62) to evaluate an SQL query to determine if it would be effective to compute hash values for the outer data source using a hash function associated with the inner table.

14. The system of claim 12, the query execution engine (58) further comprising a skew handling component to alter the routing of row from the outer data source if the hash value associated with the row from the outer data source occurs in the outer data source with a frequency greater than a threshold value.

15. The system of claim 12, the query execution engine (58) further comprising a cache maintenance component (68) to cache the row from the inner table in a probe cache at the join process.
